(19) United States
(12) Patent Application Publication
(10) Pub. No.: US 2011/0187702 A1
(43) Pub. Date: Aug. 4, 2011

(54) DRIVE-BY TOMOGRAPHY

(75) Inventor: Steven Allen Schwartz, Melbourne Beach, FL (US)

(73) Assignee: NORTHROP GRUMMAN SYSTEMS CORPORATION, Los Angeles, CA (US)

(21) Appl. No.: 12/696,094

(22) Filed: Jan. 29, 2010

(51) Int. Cl. G06T 15/00

(52) U.S. Cl. 345/419

(57) ABSTRACT

A method for constructing a tomographic image includes: (a) using at least one transmitter to transmit a signal through at least a portion of an area of interest; (b) using at least one receiver to receive the signal after the signal has passed through the area of interest; (c) extracting tomographic data from the signal; (d) repeating steps (a), (b) and (c) with the transmitter and/or receiver at different locations; (e) converting the tomographic data samples from irregularly spaced samples to a set of samples that are regularly spaced; and (f) constructing an image of the area of interest from the converted tomographic data samples. An apparatus that performs the method is also provided.

### FIELD OF THE INVENTION

The present invention relates to a method and apparatus for forming a tomographic image of a structure based on its attenuation of radio frequency signals.

### BACKGROUND OF THE INVENTION

Military personnel, law enforcement personnel and first responders encounter a variety of dangerous situations on a regular basis. One specific dangerous situation involves the need to enter a building or structure, without knowing any details about the interior. The safety of the responders and probability of success of the mission is improved if information about the interior space and its contents is known before entry. Thus it is desirable to provide information about the interior of such buildings or structures.

Stationary transmitters and receivers have been proposed in systems for generating tomographic images of objects in uncontrolled environments. It is dangerous to place stationary transmitters in the field in many applications. Some other method of collecting tomographic information is needed.

It is desirable to have a method and apparatus for producing an interior map of buildings that overcomes the limitations of the prior art in order to support first responders and urban warfare.

### SUMMARY OF THE INVENTION

In a first aspect, the invention provides a method for constructing a tomographic image including: (a) using at least one transmitter to transmit a signal through at least a portion of an area of interest; (b) using at least one receiver to receive the signal after the signal has passed through the area of interest, wherein at least one of the transmitters and/or receivers is mobile; (c) extracting a tomographic data sample from the signal; (d) repeating steps (a), (b) and (c) with the transmitter and/or receiver at different locations; (e) converting the tomographic data samples from irregularly spaced samples to a set of samples that are regularly spaced; and (f) constructing an image of the area of interest from the converted tomographic data samples.

In various embodiments, multiplicative weighting is applied to compensate for R-squared path losses. Non-uniform data are interpolated to produce data along a set of equally spaced integration lines that are oriented by equal angular amounts from each other. An example of equal angularly spaced sets of equally spaced integration lines are shown in FIG. 1.

In embodiments wherein the transmitter is stationary, the transmitter could be one intentionally emplaced or a transmitter of opportunity, such as a WiFi router, a WiFi network-card in a computer, or even a commercial radio system so long as their location may be known or derived.

In another aspect, the invention provides an apparatus including at least one transmitter for transmitting a signal through an area of interest; at least one receiver for receiving the signal after the signal has passed through the area of interest, wherein at least one of the transmitters and/or receivers is mobile; and a processor for extracting tomographic data samples from the signal, converting the tomographic data samples from irregularly spaced samples to a set of samples that are regularly spaced, and constructing an image of the area of interest from the converted tomographic data samples. Non-uniform data are re-sampled along a set of equally spaced integration lines that are offset by equal angular amounts from each other.

### BRIEF DESCRIPTION OF THE DRAWINGS

FIG. 1 is a schematic representation of a system constructed in accordance with an aspect of the invention.

FIG. 2 is a schematic diagram of how a region is integrated along a line.

FIG. 3 is a diagram of a side-to-side example.

FIG. 4 illustrates how signal strength varies with building structure.

### DETAILED DESCRIPTION OF THE INVENTION

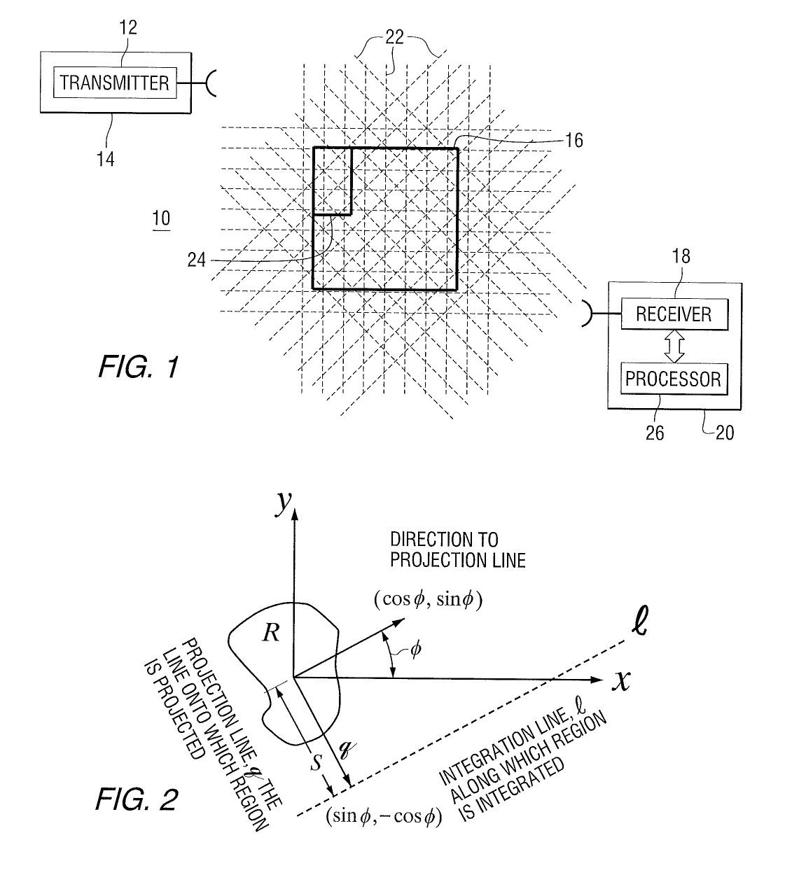

In one aspect, the invention provides a drive-by tomography system that can produce a tomographic map of an entire block of buildings or at least one building at a time. FIG. 1 is a schematic representation of a system 10 constructed in accordance with an aspect of the invention. The system includes a transmitter 12 that is mounted on, or otherwise carried by, a first mobile platform 14. The transmitter produces a radio frequency signal that is directed toward an area of interest, which may contain one or more buildings or other structures 16. A receiver 18 is mounted on, or otherwise carried by, a second mobile platform 20. The receiver receives the radio frequency signal after it has passed through the building. The transmitter and receiver move around the building in a manner such that a signal is transmitted from the transmitter to the receiver along multiple lines of sight 22. As the signal passes through the building it is attenuated due to physical characteristics of the building, such as interior walls 24, or contents of the building. This attenuation provides tomographic information. By affixing the transmitter and receiver to vehicles, the speed of the data collection process is greatly increased. FIG. 1 shows that tomographic data can be collected from multiple angles and displacements. The more angles and displacements, the better the tomographic image, but tomographic images of lower quality can be produced with sparse sampling.

A computer or other processor 26 derives tomographic information from a received signal strength parameter, such as the attenuation along the signal path. The processor then processes the tomographic information recovered from multiple transmissions and receptions, in combination with location information of the transmitter and receiver, to produce a tomographic image of the building or other structure in the area of interest. In various embodiments, multiplicative weighting is applied to compensate for R-squared path losses because path lengths vary in uncontrolled outdoor situations. As used in this description R-squared path losses model the attenuation due to spherical spreading of the signal with distance along each transmitter-receiver path. The term, R-squared, comes from the model for surface area of a sphere which spreads with the square of distance.

FIG. 1 shows four sets of lines. Each line represents one transmitter-receiver path and is called an “integration line”. A single integration line is shown in FIG. 2. In FIG. 1 each of the four sets is comprised of a number of parallel, uniformly spaced integration-lines. All the lines within one set are at the same angle. Furthermore the four sets are oriented along angles at uniform increments of 45 degrees. A group of sets of equi-spaced integration lines in which the sets are at equally spaced angle-increments as illustrated in FIG. 1 is referred to as the “regular grid”. A data collection along pathways matching a regular grid is possible but unlikely in practice. Therefore an interpolation scheme is used to produce resampled data as if the data had been collected along such a regular grid.

Non-uniform data are defined to be data that are not collected along the offsets and angles of a regular grid such as the one shown in FIG. 1.

The processor may be positioned near the receiver, for example on the same vehicle, or it may be located at a remote location. The locations of the transmitter(s) and receiver(s) at each sample point in time are conveyed to the processor via any convenient communications link.

In various embodiments, either the transmitter or receiver can be stationary. In embodiments wherein the transmitter is stationary, the transmitter could be one intentionally emplaced or a transmitter of opportunity, such as a WiFi router, a WiFi network-card in a computer, or even a commercial radio system so long as their location may be known or derived.

One type of communications link is the actual tomographic signal itself. A prototype system employed wireless sensor motes, each reporting the received signal strength of a single transmitting mote. The report was sent back to the transmitting mote which had both transmitting and receiving capability. The transmitting mote forwarded the report to a computer that was connected to it via USB interface. In cases where the communications link was so poor that the signal could not be sent back directly, it could be routed via some of the other motes.

Location information in the prototype system was measured by hand and manually tabulated. The receivers and transmitter were placed upon a special fixture developed for this purpose. A geolocation system could have been attached to each receiver and transmitter and the location information sent along with the received signal strength information. In fact, there are commercial models of sensor motes that receive GPS and report their geo-coordinates. Differential GPS or photographic techniques might be used to obtain greater accuracy.

The mobile platforms can be land vehicles or aircraft with precision global positioning system (GPS) capability to provide location information. The radio frequency signals that pass through buildings acquire tomographic information as they traverse the buildings along the line of sight. The processor can use the tomographic information together with location information for the transmitter and receiver to produce tomographic maps, or images, of the area of interest “on the fly” as needed.

In one embodiment, the system includes a transmitter and receiver each mounted on separate vehicles with precision navigation capability (such as differential GPS). These vehicles drive around a building, or possibly a city block, collecting received signal strength measurements (from transmitter to receiver). The measurements are combined with the navigation information to produce an interior map through one or more planes of buildings. If the transmitter transmits a noise-like waveform, such as the barrage jammers that are sometimes employed against improvised explosive device (IED) triggers, then the entire mapping process may be performed without drawing specific attention to itself or while serving other purposes.

Three-dimensional (3-D) information may be acquired by collecting information at multiple planes. In other words the receiver and transmitter antennas can be configured on masts at varying heights. A two-dimensional (2-D) tomographic image is created at each height. These 2-D images may be assembled into a three-dimensional (3-D) display, or, if widely spaced they might represent individual floors of a building.

Each 2-D image can be produced by populating a Fourier transform through numerous measurements, and performing an Inverse Fast Fourier Transform (IFFT). Known tomographic signal processing techniques, such as a filtered back projection, can be employed and modified to accommodate sparse sampling. The state of the art knowledge of tomographic relationships among variables is stated here.

FIG. 2 illustrates how a region is integrated along line, l in the direction along unit vector, (cos φ, sin φ). Line l may or may not pass through region R.

Let φ be the angle of an integration line l that is distance, s, from the origin. Any (x, y) coordinate pair on integration line, l, satisfies

$$\begin{matrix}s = ( \begin{matrix}x \\ y\end{matrix} ) \cdot ( \begin{matrix}sin φ \\ - cos φ\end{matrix} ) = x sin φ - y cos φ , \\ or , & ( 1 ) \\ 0 = x sin φ - y cos φ - s , & ( 2 )\end{matrix}$$

where s is the distance along the projection vector, q, to the integration line l. The value of the Radon transform of the region, R, at angle, φ, and distance, s, is simply the integral of the function along line l:

$$\begin{matrix}g ( φ , s ) = {\int }_{𝓁} f ( x , y ) d l \\ = {\int }_{- ∞}^{∞} {\int }_{- ∞}^{∞} f ( x , y ) δ ( x sin φ - y cos φ - s ) d x d y\end{matrix} \qquad ( 3 )$$

where f represents the opacity of the region R at location (x,y). This integral represents the measured attenuation of the signal through region R along a path at angle φ at offset distance, s.

The 1-D Fourier transform of the Radon transform in variable, s, is,

$$\begin{matrix}{G}_{φ} ( ω ) = {\int }_{- ∞}^{∞} g ( φ , s ) {e}^{- jω s} d s \\ = {\int }_{- ∞}^{∞} {\int }_{- ∞}^{∞} {\int }_{- ∞}^{∞} f ( x , y ) δ ( x sin φ - y cos φ - s ) \\ {e}^{- jω s} d x d y d s ,\end{matrix} \qquad ( 4 )$$

wherein the range of φ is φε[−90,90]. The value of φ after incrementing one degree past +90 degrees is −89 degrees. The range of s is sε[−∞,∞].

Using the sifting property of the delta function,

$${G}_{φ} ( ω ) = {\int }_{- ∞}^{∞} {\int }_{- ∞}^{∞} f ( x , y ) {e}^{- j ( \begin{matrix}x \\ y\end{matrix} ) \cdot ( \begin{matrix}ω sin φ \\ - ω cos φ\end{matrix} )} d x d y . \qquad ( 5 )$$

Comparing this to the 2-D Fourier transform of region, R,

$$F ( u , v ) = {\int }_{- ∞}^{∞} {\int }_{- ∞}^{∞} f ( x , y ) {e}^{- j ( \begin{matrix}x \\ y\end{matrix} ) \cdot ( \begin{matrix}u \\ v\end{matrix} )} d x d y , \qquad ( 6 )$$

one sees that the 1-D Fourier transform of the Radon transform of region, R, in the s variable provides the values of the 2-D Fourier transform of region, R, restricted to the projection line, that is,

u=ω sin φ (7)=

v=−ω cos φ. (8)

### Thus,

G_{φ}(ω)=F(ω sin φ,−ω cos φ). (9)

Because values of the 2-D Fourier transform can be obtained in this way, G_{φ}(ω) may be inverted to obtain the original image. To show this,

$$f ( x , y ) = \frac{1}{4 {π}^{2}} {\int }_{- ∞}^{∞} {\int }_{- ∞}^{∞} F ( u , v ) {e}^{j ( \begin{matrix}x \\ y\end{matrix} ) \cdot ( \begin{matrix}u \\ v\end{matrix} )} d u d v . \qquad ( 10 )$$

Make the change of variables,

u=ω sin φ (11)

v=−ω cos φ (12)

with φ is φε[−90,90] and 0≦ω. Then,

$$f ( x , y ) = \frac{1}{4 {π}^{2}} {\int }_{- π / 2}^{π / 2} {\int }_{0}^{∞} F ( ω sin φ , - ω cos φ ) {e}^{j ( \begin{matrix}x \\ y\end{matrix} ) \cdot ( \begin{matrix}ω sin φ \\ - ω cos φ\end{matrix} )} ( ω cos φ d φ + sin φ d ω ) ( ω sin φ d φ - cos φ d ω ) . \qquad ( 13 )$$

Using the Grassmann algebra for differentials,

$$f ( x , y ) = \frac{1}{4 {π}^{2}} {\int }_{- π / 2}^{π / 2} {\int }_{0}^{∞} F ( ω sin φ , - ω cos φ ) {e}^{j ( \begin{matrix}x \\ y\end{matrix} ) \cdot ( \begin{matrix}ω sin φ \\ - ω cos φ\end{matrix} )} \vert ω \vert d ω d φ . \qquad ( 14 )$$

Now substituting the previous result yields the formula for the filtered back projection image,

$$f ( x , y ) = \frac{1}{4 {π}^{2}} {\int }_{- π / 2}^{π / 2} {\int }_{0}^{∞} {G}_{φ} ( ω ) {e}^{j ( \begin{matrix}x \\ y\end{matrix} ) \cdot ( \begin{matrix}ω sin φ \\ - ω cos φ\end{matrix} )} \vert ω \vert d ω d φ . \qquad ( 15 )$$

Sampling of the RF signals can be performed at irregular intervals in both time and space.

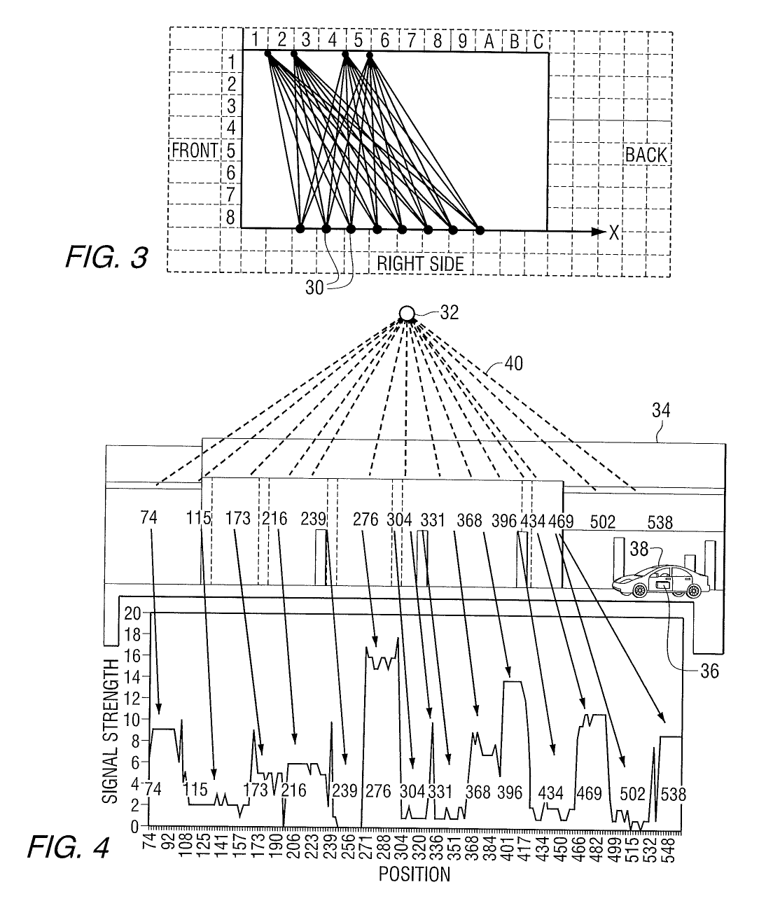

In real life situations, spatial sampling is imperfect in two ways: (1) it is irregular in angle; and (2) the pathlengths are not equal. FIG. 3 illustrates an example wherein the receiver locations are shown at the top of the figure (“1, 2, 3, 4, . . . 9, A, B, C”) and the transmitter locations at the bottom, as dots 30. That is, for each transmitter position, receivers are placed at positions (“1, 2, 3, 4, . . . 9, A, B, C”) and data recorded. After data are collected from left to right (top to bottom in the figure), then data are collected from front to back (left to right in the figure). These lines are not evenly spaced in angle (they are evenly spaced along the axes in the figure however); nor are their lengths identical. This is likely to resemble the situation in an urban environment in which the collection pathways are likely confined to sidewalks and streets. FIG. 3 shows a side to side case, showing some of the integration lines of the data collection.

This invention makes two improvements to the state of the art. One improvement provides a means of converting irregularly sampled data (in general) to regularly sampled data. Each sample of the Radon transform of a building corresponds to a line in FIG. 3. Triangular-based linear interpolation was applied to interpolate the irregularly spaced samples to a new constructed set of samples that are regularly spaced. The Matlab “griddata” function was used for this purpose. The regularly spaced samples of the Radon transform were used to create a 2-D image via filtered tomographic back projection according to the equations set forth above. The actual implementation was the Matlab “iradon” function.

The second modification to the state of the art is the application of weighting to correct for variations in path length. Because the transmitted RF signals used in this method disperse, the received signals diminish by 6 dB for every doubling of distance. These are typically referred to as 1/R squared losses. There are also atmospheric losses, but these are minimal at the WiFi frequencies employed. Because the geolocations of the receiver and transmitter are known for each measurement, the effect of pathlength is eliminated by multiplying the received signal strength indication (RSSI) by the pathlength squared. Thus a received signal of 1 nanowatt received through a 1 meter path is equivalent to a signal for 0.25 nanowatts received along a 2 meter path.

The best possible tomographic resolution is on the order of a wavelength of the transmitted signal. Therefore, the system requires an RF transmitter and receiver that operate at a wavelength that is equal to or less than the desired resolution length. In one implementation, the receiver base station is Crossbow MIB 520 interface board, and the transmitter is Crossbow Iris mote (#93) with MTS 310cb sensor module. The equipment used in this embodiment operates at 2.45 GHz and has a wavelength of approximately 5 inches.

An additional capability may be obtained by using multiple receiving and transmitting vehicles. Each additional transmitter-receiver pair at a given position provides one line through the image (for example, one of the lines in FIG. 1). These data are simply added to the dataset. In other words, the system scales easily to the addition of more transmitters and receivers. The greater the number of transmitter-receiver pairs, the faster the data may be collected. Furthermore, all of the transmitters potentially may be received by each receiver, so the data collection speed goes up very quickly as the number of transmitters and receivers are increased.

In another aspect, WiFi signals of opportunity may be used to produce part or all of a tomographic map. In the example of FIG. 4, a wireless mote 32 (which may also be a WiFi transmitter) is located in a building 34. The wireless mote sends RSSI reports to a receiver 36 on a mobile platform 38, such as a vehicle. The RSSI reports of the mote are still useful even though the transmitter power is unknown. The RSSI reports are used as relative strengths. With relative RSSI reports, the tomographic image resembles the interior building structure, but is lighter or darker depending upon the transmit power, much as a photograph or photocopy may be light or dark, yet still convey the same information. Whatever the image, it may be processed by a manual or automatic threshold in order to create a binary image in which ‘1’ represents material such as walls or furniture and ‘0’ represents empty space. The receiver is moved around the building and receives signals from the mote along various lines of sight 40.

A processor, which may be a laptop computer, receives signals from the receiver that include tomographic information, and processes those signals along with the location of the receiver to produce a tomographic image of the building. The locations of the transmitter(s) and receiver(s) must be known in order to perform the processing presented here. Any inaccuracy of location information will cause some distortion in the reconstruction.

The operating principle of the system of FIG. 4 has been demonstrated using a receiver on a vehicle that was driven in a straight line past a building containing a sensor mote, and was stopped at approximately 10 foot intervals so that the sensor mote readings could be ensured at these locations; an index into a dataset could be recorded; and a photograph could be taken from the position of the vehicle at that time of the reading. Overlays of these indices and photographs relative to the building show that there is good correlation between the received signal strength indication (RSSI) and the location of obstacles or building features in the path of the transmitted signal. The signal is weakest when there are obstacles in the path. This evidence supports the contention that RF tomography of buildings is possible. FIG. 4 includes a graph of the received signal strength that varies with building structural elements.

RF tomography would be performed by collecting data along various lines of sight. This could be accomplished by using moving sources and receivers, as in the system of FIG. 1. A tomographic back projection is then applied to the data in order to produce a two-dimensional map of the building interior. The reconstructed image gets better and better as more data are collected at more projection angles. The image may still include artifacts, but trained tomographic analysts might reasonably be expected to make the correct inference because these types of artifacts (are assumed) to always happen in the same way.

In another embodiment, the system might concentrate upon collecting data at projection angles that are similar to the wall angles. This system might work well enough in buildings that are constructed with right angles. An acceptable reconstruction can be obtained with asymmetrical sampling in this fashion. This implies that good reconstruction could be collected from evenly spaced samples collected along a street.

The invention encompasses both the method described above and apparatus that performs the method. While the invention has been described in terms of several embodiments, it will be apparent to those skilled in the art that various changes can be made to the described embodiments without departing from the scope of the invention as set forth in the following claims.

What is claimed is:

1. A method comprising:
(a) using at least one transmitter to transmit a signal through at least a portion of an area of interest;
(b) using at least one receiver to receive the signal after the signal has passed through the area of interest, wherein at least one of the transmitters and/or receivers is mobile;
(c) extracting a tomographic data sample from the signal;
(d) repeating steps (a), (b) and (c) with the transmitter and/or receiver at different locations;
(e) converting the tomographic data samples from irregularly spaced samples to a set of samples that are regularly spaced; and
(f) constructing an image of the area of interest from the converted tomographic data samples.

2. The method of claim 1, wherein the step of constructing an image of the area of interest applies multiplicative weighting to compensate for R-squared path losses.

3. The method of claim 1, wherein the irregularly spaced samples are re-sampled on a regular grid using interpolation.

4. The method of claim 1, wherein the step of constructing an image of the area of interest uses an inverse Radon transform of raw or interpolated received signal strength measurements.

5. The method of claim 1, wherein the step of constructing an image of the area of interest converts irregularly sampled data to regularly sampled data using interpolation.

6. The method of claim 5, wherein the interpolation comprises linear interpolation.

7. The method of claim 1, wherein the step of constructing an image of the area of interest weights the signals to correct for variations in path length.

8. The method of claim 1, wherein the signal comprises:
a noise-like signal.

9. The method of claim 1, wherein the transmitter is stationary and the transmitted signals are signals of opportunity

10. The method of claim 1, wherein the step of constructing an image of the area of interest comprises:
populating a Fourier transform through numerous measurements; and
performing an Inverse Fast Fourier Transform.

11. An apparatus comprising:
one or more transmitters for transmitting a signal through at least a portion of an area of interest;
one or more receivers for receiving the signal after the signal has passed through the area of interest, wherein at least one of the transmitters and/or receivers is mobile; and
a processor for extracting tomographic data samples from the signal, converting the tomographic data samples from irregularly spaced samples to a set of samples that are regularly spaced, and constructing an image of the area of interest from the converted tomographic data samples.

12. The apparatus of claim 11, wherein the processor applies multiplicative weighting to compensate for R-squared path losses.

13. The apparatus of claim 11, wherein the irregularly spaced samples are re-sampled on a regular grid using interpolation.

14. The apparatus of claim 11, wherein the processor uses an inverse Radon transform of raw or interpolated received signal strength measurements.

15. The apparatus of claim 11, wherein the processor converts irregularly sampled data to regularly sampled data using interpolation.

16. The apparatus of claim 15, wherein the interpolation comprises linear interpolation.

17. The apparatus of claim 11, wherein the processor weights the signals to correct for variations in path length.

18. The apparatus of claim 11, wherein the signal comprises:
a noise-like signal.

19. The apparatus of claim 11, wherein the processor populates a Fourier transform through numerous measurements and performing an Inverse Fast Fourier Transform.
